(19) United States
(12) Patent Application Publication
(10) Pub. No.: US 2002/0086768 A1
(43) Pub. Date: Jul. 4, 2002

(54) Kickdown control method for a CVT of a vehicle

(76) Inventor: Seong-Uk Kim, Yongin-city (KR)

Correspondence Address: Pennie & Edmonds, LLP, 3300 Hillview Avenue, Palo Alto, CA, 94304, US

(21) Appl. No.: 10/028,209

(22) Filed: Dec. 21, 2001

(30) Foreign Application Priority Data
Dec. 28, 2000 (KR) 2000-83980

(51) Int. Cl. B60K 41/14

(52) U.S. Cl. 477/44; 477/45

(57) ABSTRACT

A kickdown control method for a continuously variable transmission for a vehicle, in which an acceleration response can be increased, comprises the steps of: determining if conditions for kickdown are satisfied; rapidly discharging a primary pressure from a primary pulley if it is determined that the conditions for the kickdown are satisfied; and regulating a primary pressure solenoid duty ratio to a null position to prevent an engine speed from suddenly increasing, and controlling a gear ratio by performing a feedback control.

### BACKGROUND OF THE INVENTION

The present invention relates to a kickdown control method for a continuously variable transmission of a vehicle, and more particularly, to a method in which an acceleration response can be increased by rapidly discharging a primary pressure that acts on a primary pulley if conditions for kickdown are satisfied.

Generally, a continuously variable transmission (CVT) system performs a gear shift by continuously changing a gear ratio of a primary pulley and a secondary pulley.

FIG. 1 shows a control system for the CVT. As shown in FIG. 1, in a CVT system, power provided from an engine 10 is transmitted to a primary pulley 11 and is then transmitted to a secondary pulley 12 via a belt extended between the primary pulley and the secondary pulley.

A transmission control unit (TCU) 20 detects a clutch pressure, a cluster gear RPM, a secondary pulley RPM, a primary pulley RPM and a transmission oil temperature.

The TCU 20 controls the clutch pressure, the line pressure and the primary pressure by controlling a clutch pressure solenoid duty ratio, a line pressure solenoid duty ratio and a primary pressure solenoid duty ratio on the basis of an idle switch signal and a throttle position signal that are provided from an electric control unit (ECU) that controls the engine.

Generally, a primary pressure solenoid is arranged such that the higher the primary pressure solenoid duty ratio is, the smaller the primary pressure is. If the primary pressure duty ratio becomes higher, the primary pressure becomes smaller and a gear ratio becomes larger and therefore output torque becomes larger.

Also, the TCU 20 detects a shift range signal and transmits the same to the ECU 30.

If a driver depresses an accelerator pedal to rapidly accelerate a vehicle, a kickdown shift occurs. The kickdown shift means that a down-shift occurs such that torque sufficient to accelerate the vehicle can be acquired.

In a belt-pulley type CVT, if the accelerator pedal is depressed to rapidly accelerate the vehicle, the primary pressure solenoid duty ratio is controlled to increase so that the down shift occurs.

However, the aforementioned kickdown control method according to the prior art cannot rapidly accelerate the vehicle.

### SUMMARY OF THE INVENTION

According to the present invention, a kickdown control method is provided in which a primary hydraulic pressure is rapidly discharged for increasing an acceleration response if conditions for the kickdown are satisfied. In a preferred embodiment, the method according to the present invention includes steps of determining if conditions for kickdown are satisfied, rapidly discharging a primary pressure from a primary pulley if it is determined that the conditions for the kickdown are satisfied, and regulating a primary pressure solenoid duty ratio to a null position to prevent an engine speed from suddenly increasing and performing a feedback control.

In a further preferred embodiment the determination of kickdown conditions is made by determining if a vehicle speed is higher than a predetermined critical speed, determining if a gear ratio is smaller than a predetermined critical ratio, determining if a throttle opening angle is greater than a predetermined critical angle, and determining if a throttle opening angle change ratio is greater than a predetermined critical ratio.

In an alternative preferred embodiment, the present invention monitors selected vehicle performance parameters and compares the monitored parameters to predetermined values. If it is determined that the monitored parameters exceed predetermined critical values, the conditions for kickdown are found to exist. In such a case the primary pressure solenoid duty ratio is increased to reduce primary pressure at the primary pulley and increase acceleration response. Thereafter the primary pressure solenoid duty ratio is regulated to prevent sudden engine speed increase and transmission the gear ratio is controlled to approach a target ratio.

In a further alternative embodiment, a system for controlling kickdown in a continuously variable transmission is provided. The system comprises a control unit programmed to receive signals representative of vehicle speed, transmission gear ratio, throttle opening angle. In addition, the control unit includes a processor containing instructions for calculating a throttle opening angle rate of change, determining whether vehicle speed is greater than a predetermined critical speed, determining whether the gear ration is less than a predetermined critical gear ratio, determining whether the throttle opening angle is greater than a predetermined critical opening angle, determining whether the calculated throttle opening rate of change is greater than a predetermined critical rate of change, increasing the primary pressure solenoid duty ratio as in response to positive determination in said determining steps, regulating the primary pressure solenoid duty ratio to prevent sudden engine speed increase, and controlling the gear ratio to approach a target ratio.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a schematic block diagram of a control system for a continuously variable transmission;

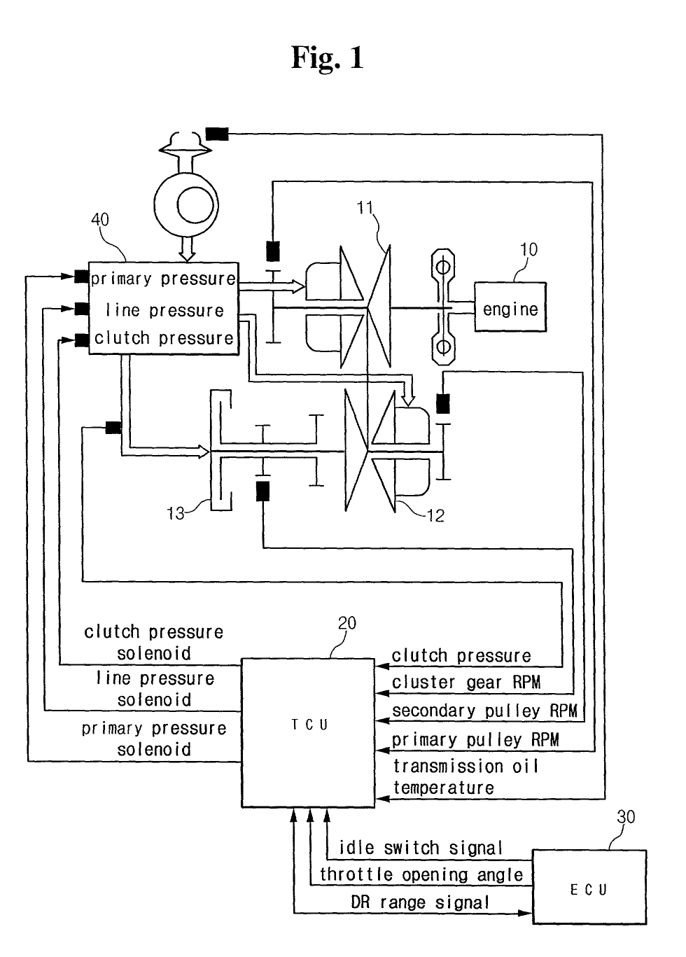

FIG. 2 is a flow chart of a kickdown control method for the continuously variable transmission according to the present invention; and

FIG. 3 illustrates a change of a primary pressure solenoid duty ratio with reference to a change of a throttle position according to the prior art and the present invention, respectively.

### DETAILED DESCRIPTION OF THE PREFERRED EMBODIMENTS

Hereinafter, a preferred embodiment of the present invention will be described in detail with reference to the accompanying drawings.

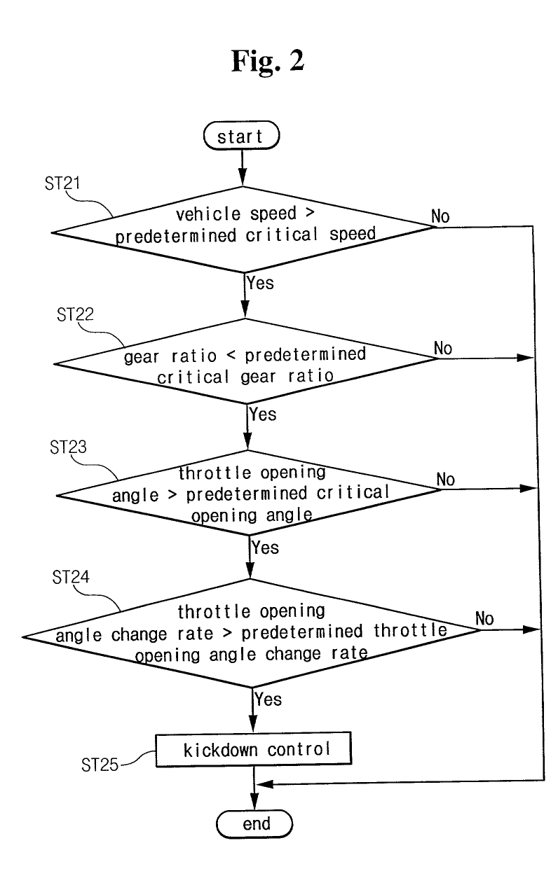

According to a preferred embodiment of the invention, the transmission control unit (TCU) 20 detects a vehicle speed as sensed by a vehicle speed sensor and a gear ratio sensed by a gear ratio sensor, then, as illustrated in FIG. 2, the TCU 20 determines if the vehicle speed is higher than a predetermined critical vehicle speed (ST21).

It is preferable that the predetermined critical vehicle speed is determined as a value above which the kickdown control does not have adverse effects on the vehicle and one at which it is needed to perform the kickdown control according to the present invention.

If it is determined that the vehicle speed is higher than the predetermined critical vehicle speed in step ST21, the TCU 20 determines if the gear ratio is smaller than a predetermined critical gear ratio (ST22).

If the gear ratio is so high that enough torque to accelerate the vehicle is generated, there is little necessity for performing the kickdown control according to the present invention. Therefore, it is preferable that the predetermined critical gear ratio is determined as a value below which it is needed to perform the kickdown control according to the present invention.

If it is determined that the gear ratio is smaller than the predetermined critical gear ratio in step ST22, the TCU 20 detects a throttle opening angle sensed by a throttle position sensor and calculates a throttle opening angle change rate according to time, and the TCU 20 then determines if the throttle opening angle is greater than a predetermined critical angle (ST23).

If it is determined that the throttle opening angle is greater than the predetermined critical angle in step ST23, the TCU 20 determines if the throttle opening angle change rate is greater than a predetermined critical rate (ST24).

It is preferable that the predetermined critical throttle opening angle and the predetermined critical throttle opening angle change rate are determined as values above which it is needed to increase the acceleration response.

If it is determined that the throttle opening angle change rate is greater than the predetermined critical rate in step ST24, the TCU 20 controls the kickdown to be performed (ST25). That is, in steps ST21 through ST24, it is determined if conditions for kickdown are satisfied.

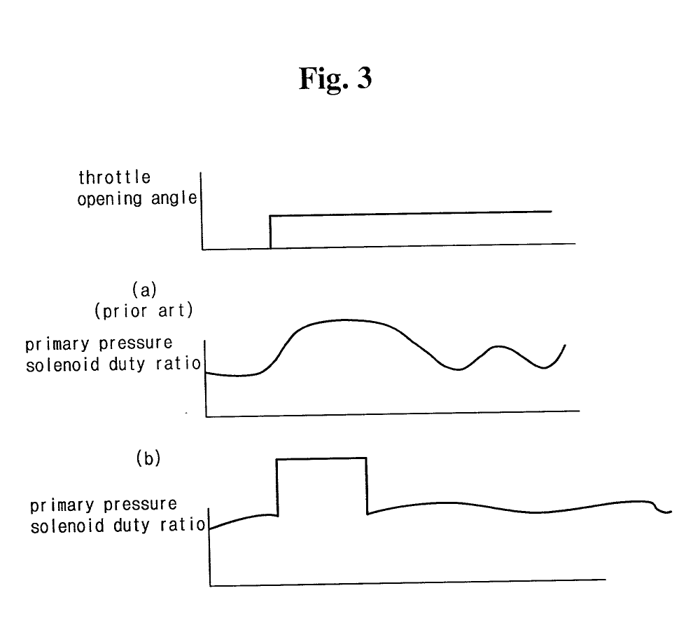

FIG. 3(a) and (b) are graphs respectively showing the changes of the primary pressure solenoid duty ratio according to the prior art and a preferred embodiment of the present invention.

If the primary pressure solenoid duty ratio is controlled as shown in FIG. 3(a), the primary pressure is slowly discharged from the primary pulley so that the acceleration response decreases.

As shown in FIG. 3(b), when the throttle opening angle increases rapidly, the TCU 20 controls the primary pressure to be rapidly discharged from the primary pulley by rapidly increasing the primary pressure solenoid duty ratio. Therefore, the acceleration response can be increased.

After the primary pressure is rapidly discharged in the beginning of the kickdown control as shown in FIG. 3(b), the TCU 20 regulates the primary pressure solenoid duty ratio to a null position such that an overshoot phenomenon, whereby engine speed is suddenly increased, does not occur.

Then, the TCU 20 controls the gear ratio by performing a feedback control, based on a deviation between a target gear ratio and a present gear ratio, in order that the present gear ratio may approach the target gear ratio.

On the other hand, if any one condition for the kickdown is not satisfied in step ST21 to ST24, the TCU 20 stops the kickdown control, and a control logic returns to a main routine. Also, after the kickdown control is performed in step ST25, the control logic returns to the main routine.

As stated above, the kickdown control method according to the present invention makes it possible to increase the acceleration response when the driver wants to accelerate the vehicle.

Although preferred embodiment of the present invention have been described in detail hereinabove, it should be clearly understood that many variations and/or modifications of the basic inventive concepts herein taught which may appear to those skilled in the present art will still fall within the sprit and scope of the present invention, as defined in the appended claims.

What is claimed is:

1. A kickdown control method for a CVT of a vehicle comprising:
(a) determining if conditions for kickdown are satisfied;
(b) rapidly discharging a primary pressure from a primary pulley if it is determined that the conditions for the kickdown are satisfied; and
(c) regulating a primary pressure solenoid duty ratio to a null position to prevent an engine speed from suddenly increasing, and controlling a gear ratio by performing a feedback control.

2. The kickdown control method of claim 1 wherein step (a) comprises;
determining if a vehicle speed is higher than a predetermined critical speed.

3. The kickdown control method of claim 2 wherein step (a) further comprises;
determining if a gear ratio is smaller than a predetermined critical ratio.

4. The kickdown control method of claim 3 wherein step (a) further comprises;
determining if a throttle opening angle is greater than a predetermined critical angle.

5. The kickdown control method of claim 4 wherein step (a) further comprises;
determining if a throttle opening angle change rate is greater than a predetermined critical rate.

6. A method for controlling kickdown in a continuously variable transmission (CVT) including a primary pulley operating at a gear ratio responsive to a primary hydraulic pressure controlled by a primary pressure solenoid duty ratio, the method comprising
monitoring selected vehicle performance parameters;
comparing said selected performance parameters to predetermined values;
determining if conditions for kickdown exist based on said comparing;
increasing the primary pressure solenoid duty ratio when kickdown conditions exist to reduce primary pressure and increase acceleration response;
regulating the primary pressure solenoid duty ration to prevent sudden engine speed increase; and
controlling the gear ratio to approach a target ratio.

7. The method according to claim 6, wherein said vehicle performance parameters include at least one of vehicle speed, transmission gear ratio, throttle opening angle and throttle opening angle rate of change.

8. The method according to claim 7, wherein each of said parameters must reach a predetermined critical value for kickdown conditions to exist.

9. A system for controlling kickdown in a continuously variable transmission (CVT) including a primary pulley operating at a gear ratio responsive to a primary hydraulic pressure controlled by a primary pressure solenoid duty ratio, the system comprising a control unit programmed to receive signals representative of vehicle speed, transmission gear ratio, throttle opening angle, and including instructions for:
calculating a throttle opening angle rate of change
determining whether vehicle speed is greater than a predetermined critical speed;
determining whether the gear ration is less than a predetermined critical gear ratio;
determining whether the throttle opening angle is greater than a predetermined critical opening angle;
determining whether the calculated throttle opening rate of change is greater than a predetermined critical rate of change;
increasing the primary pressure solenoid duty ratio as in response to positive determination in said determining steps;
regulating the primary pressure solenoid duty ratio to prevent sudden engine speed increase; and
controlling the gear ratio to approach a target ratio.
